(19) United States
(12) Patent Application Publication
(10) Pub. No.: US 2004/0006409 A1
(43) Pub. Date: Jan. 8, 2004

(54) Active acoustic spectroscopy

(76) Inventors: Thomas Liljenberg, Vasteras (SE); Stefan Backa, Karlstad (SE); Lennart Thegel, Vasteras (SE); Mats Abom, Jarfalla (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/332,955

(22) PCT Filed: Jul. 6, 2001
(86) PCT No.: PCT/SE01/01565

(30) Foreign Application Priority Data
Jul. 14, 2000 (SE) 0002667-4

(51) Int. Cl. G01N 29/02; G06F 19/00

(52) U.S. Cl. 700/266; 702/32; 702/56; 73/602; 73/24.01; 73/64.53

(57) ABSTRACT

In the prevent invention a controllable acoustic source (14) in connection with the process fluid (10) emits a signal (18) into the fluid (10), consisting of a suspension of particles (12), being volumes of gas, liquid or solid phase. The controllable acoustic signal (18) is allowed to interact with the particles (12), and the acoustic (pressure) signals (22) resulting from such an interaction is measured preferably via a sensor (24). A spectrum is measured. The spectrum is used to predict properties, content and/or size of the particles (12) and/or used to control a process in which the process fluid (10) participates. The prediction is performed in the view of the control of the acoustic source (14). The used acoustic signal has preferably a frequency below 20 kHz.

### TECHNICAL FIELD

The present invention generally relates to methods for monitoring properties of process fluids (gases or liquids) by acoustic analysis and devices for performing the method. The present invention also relates to process systems involving process fluids and methods for controlling the systems, based on acoustic analysis. In particular, the present invention is directed to process fluids having suspended or emulgated gas, liquid or solid volumes, i.e., multi-phase fluids. In the following description this will simply be referred to as “a fluid having suspended particles”, even if the “particles” may involve gas or liquid phases.

### BACKGROUND

In many production process systems, a fluid having suspended particles is used, either as a raw material, an intermediate product or a final product Examples may be found in widely differing areas, such as pulp or paper industries, pharmaceutical industries, food processing, building material fabrication, etc. Common for many of the processes is that the inherent properties, size or concentration of the suspended particles are of crucial importance for the final product. Therefore, there is a general desire to find methods for analysing the properties of the particles in a fast, accurate, safe, cheap and easy manner in order to predict the final product quality and to be able to control the processing steps accordingly.

Some basic types of measurement philosophies exist for process fluids; “off-line”, “on-line”, “at-line” and “in-line”.

The classical off-line procedure is to extract samples of the process fluid for analysis in a laboratory. However, in this way only a part of the process fluid is analysed, and the possible feedback of such an analysis is generally slow.

An analysis method suitable for providing data for control purposes has to be performed in direct contact with the actual process fluid flow.

To speed up the off-line procedure (up to 5-10 times) an on-line procedure with automatic sampling systems have been developed in which measurements based on, e.g., optical measurement techniques are used. Typically such systems operate by diverting a small portion of the process fluid into a special pipe or volume. One example being the PQM system (Pulp Quality Monitor) from Sunds Defibrator, which measures freeness, fibre length and shive content in a pulp suspension. A common problem with all off-line and some on-line and at-line methods is that only a part of the flow is measured. The properties in such a diversion flow may differ from the main flow. TCA (Thermomechanical pulp Consistency Analyser) from ABB AB measures the consistency of the pulp. The system is using fibre optic techniques. Other similar systems are the Smart Pulp Platform (SPP™) available from ABB, and “Fiber Master” developed by the Swedish pulp and paper research institute (STFI).

In-line methods, which operates directly on the entire process fluid without extracting fluid into a special test space, are generally faster than off-line methods and can reduce some of the problems listed for these methods. However, mechanical devices have to be inserted in the process line in order to extract the flow sample, which may disturb the main flow and which makes maintenance or replacement work difficult. Furthermore sensors may be contaminated, or the flow may be contaminated by the sensors.

An alternative to use optical or electromagnetic waves is to use mechanical (acoustical) waves. This has several advantages. Acoustic waves are enviromentally friendly and also unlike electromagnetic waves they can propagate in all types of fluids.

In the article “Ultrasonic propagation in paper fibre suspensions” by D. J. Adams, 3rd International IFAC Conference on Instrumentation and Automation in the Paper, Rubber and Plastics Industries, p. 187-194, Noordnederlands Boekbedrijf, Antwerp, Belgium, it is disclosed to send ultrasonic beams of frequencies between 0.6 MHz and 15 MHz through a suspension of fibres and the attenuation as well as the phase velocity can be measured as a function of frequency, It is by this possible to obtain information about fibre concentration, size and to some extent the fibre state. However, an elaborate calibration procedure is necessary in order to make the method operable.

In “Pulp suspension flow measurement using ultrasonics and correlation” by M. Karras, E. Harkonen, J. Tornberg and 0. Hirsimaki, 1982 Ultrasonics Symposium Proceedings, p. 915-918, vol. 2, Ed: B. R. McAvoy, IEEE, New York, N.Y., USA, a transit time measurement system is disclosed. The system measures primarily the mean flow velocity and tests from various pulp suspensions are described. Doppler shift measurements are used to determine velocity profiles. A frequency of 2.5 MHz was used.

In U.S. Pat. No. 3,710,615, a device and method for measuring of particle concentrations in fluids is disclosed. An acoustic wave of one wavelength is emitted into a fluid containing particles. The amplitude of the acoustic signal is registered and the attenuation of the acoustic signal is deduced. Based on this attenuation, a particle concentration is determined. One embodiment where two frequencies are used is also described. Frequencies of 1 MHz and 200 kHz are mentioned.

In U.S. Pat. No. 5,714,691, a method and system for analysing a two phase flow is presented. An ultrasonic signal is introduced in a two phase flow and the echo signals are registered by a set of sensors. The flow rate and flow quality is determined based on these measurements. Furthermore, the results are used for regulate the flow. Excluding flow characteristics are discussed.

In the French patent publication FR 2 772 476 a method and a device for monitoring phase transitions are described. The method uses measurements of wave propagation velocities to estimate viscoelastic properties of e.g. milk products, which are subjects to phase transitions. Preferred frequencies are above 10 kHz.

In the international patent application WO 99/15890 a method and a device for process monitoring using acoustic measurements were disclosed. Inherent acoustical fields in the system (up to 100 kHz) are recorded indirectly via wall vibration measurements on a conveyor line, through which a fibre suspension flows. The recordings are graded by a data manipulation program according to predetermined characteristics and a vibration characteristics is generated. Stored vibration characteristics related to earlier recordings are compared at each recording for correlation to the properties of the suspension. The recorded vibrations can be used for controlling the process in a suitable way, for raising alarms at fault situations or for showing changed tendencies.

In the international patent application WO 00/00793, measurements of fluid parameters in pipes are presented. A speed of sound is determined by measuring acoustic pressure signals at a number of locations along the pipe. From the speed of sound, other parameters, such as fluid fraction, salinity etc. can be deduced. Frequencies below 20 kHz are used. Preferably, the method operates only on noise created within the system itself. However, an explicit acoustic noise source may be used.

Since the method used in the above patents is based on a method which makes use of inherently appearing vibrations, or other noise signals, a number of problems result. One being that not only will sound generated in the fluid be picked up but also vibrations from mechanical sources, e.g., pumps, connected to the fluid. This leads to large amounts of disturbances, which increases the amount of averaging or overdetermination. Furthermore, since there are no control of the source process methods for suppressing disturbances are difficult to apply. In addition the suggested method must be calibrated for each individual site, since the inherent vibrations are site dependent. This last aspect is a considerable practical limitation since it will cause very large losses in production upon installation.

### SUMMARY

A general object of the present invention is to improve the characterisation of a process fluid and thereby to control the process in which the process fluid takes part. One object of the present invention is therefore to eliminate the system specificity. This will make the identification independent of the rest of the system and calibration will not depend on the location but only on the process fluid involved. Another object is to improve the ratio “signal-noise” or “signal-disturbances” in system identification measurements. Yet another object of the present invention is to clarify the relations between measured signals and properties of the process fluid. A further object is also to make the data treatment of measurement more efficient.

The above objects are achieved by methods and apparatuses according to the enclosed claims. In general words, a controllable acoustic source in contact with the process fluid emits an acoustic signal into the fluid, consisting of a suspension of particles. “Particles” are in the present application generally defined as volumes of gaseous, liquid or solid phase. Preferably, volumes of a phase different from the fluid is considered. The controllable acoustic signal, controllable by frequency, amplitude, phase and/or timing, interacts with the particles, and a spectrum of the acoustic signals (pressure, wall vibrations) resulting from such an interaction is measured via a sensor. The measured spectrum is correlated to properties, content and/or size of the particles and/or used to control a process in which the process fluid participates. The correlation is performed in view of the control of the acoustic source. The measured spectral component has preferably a wave length that is large compared to the typical size of the process fluid particles and distance between the process fluid particles. The used acoustic signal is typically of a frequency below 20 kHz.

Since the emitted acoustic signal is controllable, by amplitude, frequency, phase and/or time-delay, the controllable acoustic signal can be selected to emphasise acoustic behaviours of the particles/volumes in the process fluid, e.g. by tuning the frequency to characteristic frequencies of the particles/volumes. Furthermore, the signal can comprise one or several single frequencies or frequency bands, which also may vary with time. The controllable acoustic signal may also be emitted during limited time intervals or being amplitude modulated, which enables different noise and disturbance removal procedures on the measured acoustic signals in order to increase the signal/noise ratio.

By measuring not only frequency and corresponding amplitude of the resulting acoustic signal, but also phase, time or spatial dependencies, statistical modelling based on, e.g., multivariate analysis or neural networks may be utilised to make the analysis further robust The spatial dependence is realised by using special geometric arrangements of sensors along and/or perpendicular to the flow direction.

According to the present invention, information from the measured acoustic signals may also be used for controlling different subprocesses in a process system. The measurements may be performed upstream of a subprocess in order to characterise the process fluid entering the subprocess, i.e. feedforward information, and/or downstream of a subprocess in order to provide feedback information about the result of the subprocess.

The methods and devices are suitable for use in e.g. paper pulp processes, and may e.g. be used to control the operation of a refiner.

The advantages with the present invention is that it provides a monitoring and/or controlling method which is non-destructive, environmentally friendly and provides, depending on the averaging necessary, data in “real-time”. The controllability of the acoustic source and the possibility to tune the frequency to a specific range makes it possible to emphasise important spectral characteristics of the process fluid and allows for noise and disturbance reduction. Furthermore, with a controllable acoustic source different acoustic propagation paths can be excited and used for analysis purposes. The present invention also provides the opportunity for multi-component analysis and can be utilised for different material phases. No sample treatment is involved and the new method has the potential of being possible to use within a large concentration range and also at high temperatures. Finally, laboratory tests have demonstrated the feasibility of the method to perform “real-time” measurements of size and stiffness for cellulose fibres.

Further advantages and features are understood from the following detailed description of a number of embodiments.

### BRIEF DESCRIPTION OF THE DRAWINGS

The invention, together with further objects and advantages thereof, may best be understood by making reference to the following description taken together with the accompanying drawings, in which:

FIG. 1 is a schematic drawing of an analysing device according to the present invention;

FIG. 2 is a flow diagram of a system identification process according to the present invention;

FIG. 3a and 3b are schematic drawings of process control systems according to the present invention providing feed-forward and feed-back, respectively;

FIG. 4 is a flow diagram of a process control method according to the present invention;

FIG. 5a-5i are diagrams illustrating examples of emitted acoustic signals or measured acoustic signals in different simplified situations;

FIG. 6a-6c are schematic drawings illustrating sensor array configurations;

FIG. 7 is a schematic illustration of an embodiment of a refiner line according to the present invention; and

FIG. 8 is a schematic illustration of an embodiment of a pharmaceutical process line according to the present invention.

### DETAILED DESCRIPTION

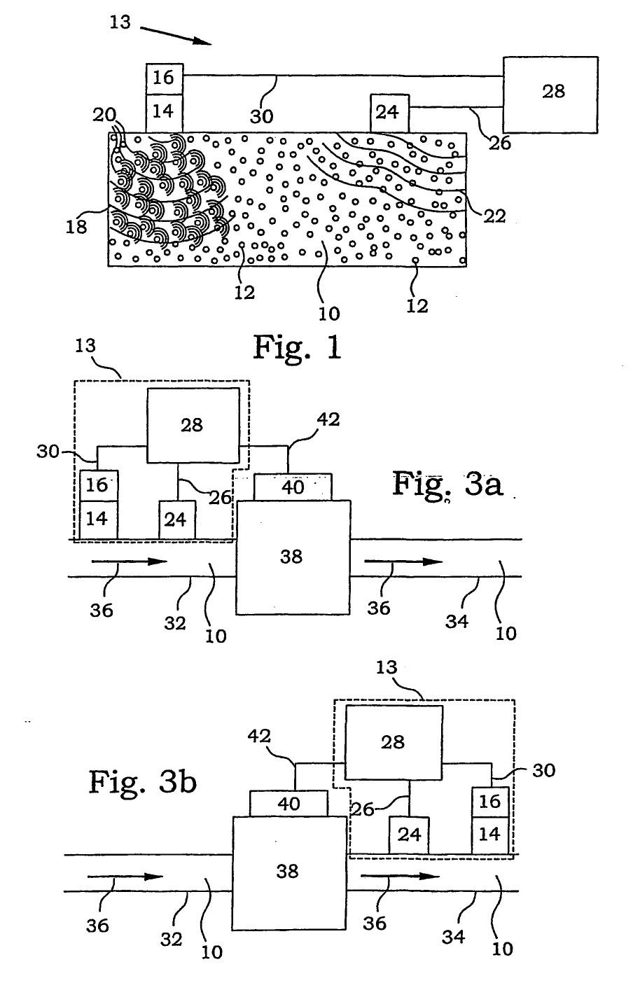

FIG. 1 illustrates an analysing device 13 for a process system involving a process fluid 10. The process fluid 10 comprises suspended particles 12 of gas, liquid or solid phase. The process fluid may e.g. be a gas containing solid particles, a gas containing liquid droplets, a suspension of solid particles in a liquid, an emulsion of liquid droplets in another liquid, a liquid containing gas volumes or any combination of such fluids. An analysing device 13 is used to evaluate the properties of the process fluid 10 and the particles 12 therein. The analysing device comprises an emitter 14, which constitutes an acoustic signal source, and a control unit 16 for operating the emitter 14. The emitter 14 is arranged to emit acoustic signals into the process fluid 10. Acoustic signals 18 are propagating as waves through the process fluid 10 and will then be influenced by the presence of the suspended particles 12.

This influence will, for waves with a wavelength much larger than the size of the particles and distance between them, mainly manifest itself as a changed fluid compressibility. This will lead to a change in the phase speed and to absorption of the acoustic signals 18 which will be frequency dependent. In particular large changes can be expected in frequency ranges where the suspended particles 12 exhibit resonant vibration behaviour. The resonance frequencies depend e.g. on density, dimensions, stiffness, bonding within the particle and bonding between particles and many other properties. This frequency range is for almost all practical applications located in the audible subultrasonic region, i.e. below 20 kHz. Since the influence of even small particle concentrations, e.g. air bubbles in water, on fluid compressibility can be very large, a method based on long waved acoustic signals is potentially very sensitive for detecting fluid mite variations. Of course this high sensitivity also implies that special measures might be needed to control any unwanted influence on the fluid properties. This can be achieved by applying special signal processing techniques, as discussed further below.

Furthermore, by using frequencies well below the ultrasonic range coherent signals can be provided making measurements of both amplitude and phase response possible. This is described further in detail below.

The particles 12 will thus influence the acoustic transmission properties (phase speed) of the process fluid and absorb vibration energy and thereby change the originally emitted acoustic signals. The vibrating particles 12 will also themselves emit energy in the form of acoustic signals 20. These signals will typically be in the same frequency range as the particle vibrations, i.e. in the frequency range below the ultrasonic range. The modified emitted acoustic signals 18 from the emitter 14 and the acoustic signals emitted from the particles 20 will together form a resulting acoustic signal 22.

An acoustic signal sensor 24 is arranged at the system for measuring acoustic signals in the process fluid 10. At least one component of the acoustic spectrum of the acoustic signals is measured. These acoustic signals are the resulting signals 22 from the interaction between the emitted acoustic signals 18 and the particles 12. Since the interaction between acoustic signals and the particles 12 is indicative of the nature of the particles 12, the measured acoustic signals comprise information related to the particles 12 suspended in the process fluid 10. The analysing device further comprises a processor 28, which is connected to the sensor 24 by a sensor connection 26. The processor 28 is an evaluation unit arranged for correlating the measured acoustic signals to properties, content or distribution of the particles 12 within the process fluid 10. The emitter control unit 16 is preferably controllable by the processor 28 through an emitter connection 30 in order to tune or control the emitted acoustic signals dependent or coordinated with the measurement operation.

In a typical case, the processor 28 operates according to a certain model of the involved system. The model is preferably based on theories about the physical interaction between the particles and the acoustic waves. The model or parameters in the model are calibrated by using a set of acoustic signal measurements and corresponding laboratory measurements of the particle properties of interest. The model is then possible to use for predicting the particle properties from acoustic spectra of unknown samples.

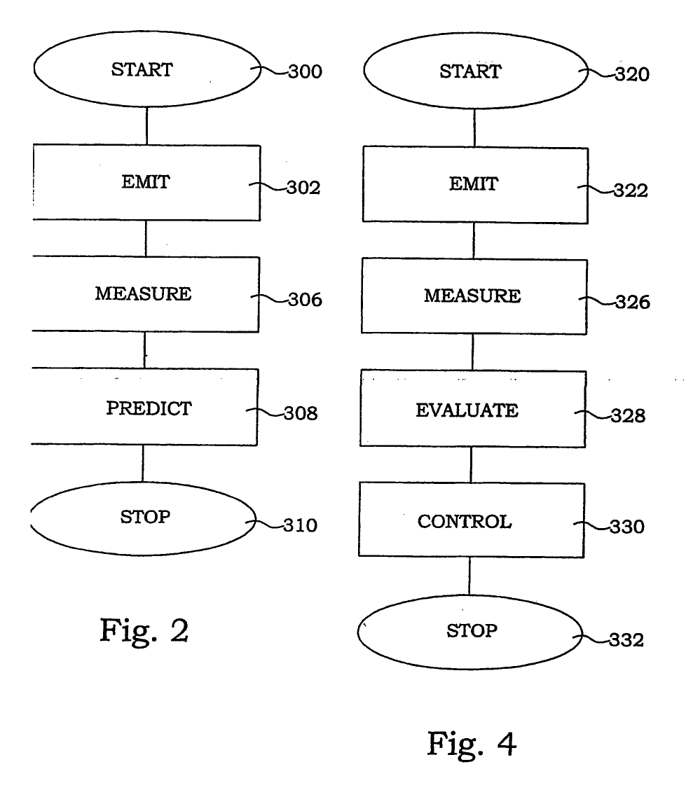

A corresponding method for system identification is illustrated in the flow diagram of FIG. 2. The procedure starts in step 300. In step 302, an acoustic signal of sub-ultrasonic frequencies is emitted into a process fluid comprising suspended particles. The acoustic signals interact with the suspended particles and give rise to a resulting acoustic signal. This resulting acoustic signal is measured in step 306 and in step 308, the measurement results are used to predict the properties of the particles in the fluid e.g. according to a pre-calibrated model. The predicted properties are preferably mechanical or chemical data, concentrations, distributions and sizes of the particles. If the system identification is performed in a process system, the prediction may also be connected to properties of products manufactured by the process fluid. The procedure ends in step 310.

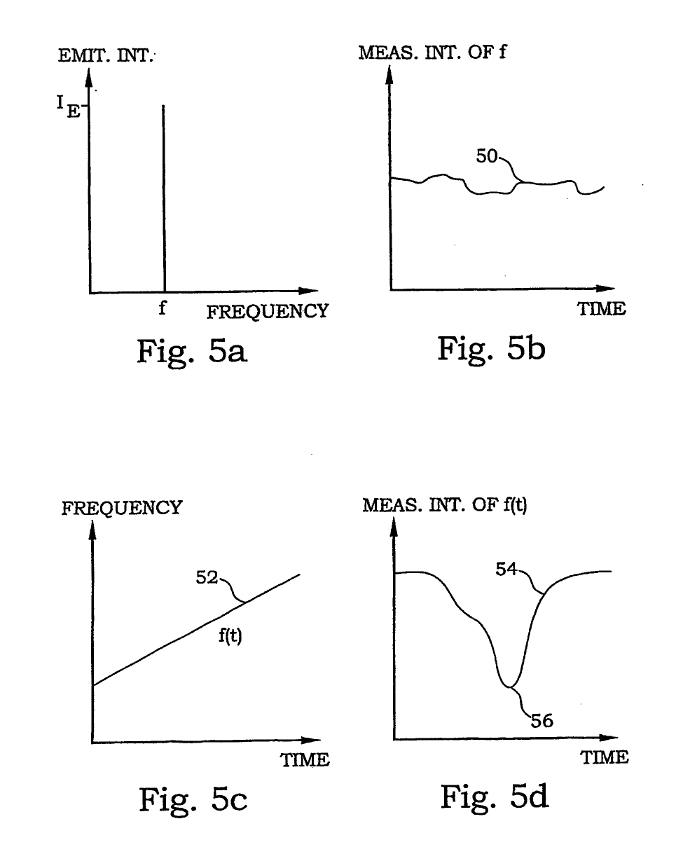

FIG. 3a illustrates a general process system involving a process fluid 10. A flow inlet 32 guides the process fluid 10 into a subprocess device 38, in which the process fluid is influenced. The process fluid 10, typically in a modified state, leaves the subprocess device 38 in a flow outlet 34. The process fluid thus flows in the direction of the arrows 36, from the left to the right in FIG. 3a. An analysing device 13 as described above is arranged on the upstream flow inlet 32, and is arranged to analyse particles within the process fluid 10, before the process fluid enters the subprocess device 38. The processor 28 uses acoustic spectrum information to predict properties of the particles of the process fluid 10 e.g. according to a pre-calibrated model. Properties, which are of importance for the following subprocess, can thereby be monitored. An operator can e.g. use this information to control the subprocess accordingly or the values of the predicted particle properties can be used as input parameters in available conventional process control means.

A process control unit 40 controls the operation parameters of the subprocess and is connected by a control connection 42 to the processor 28 of the analysing device 13. By supplying the processor 28 with information about how the parameter settings of the subprocess influence the properties of the process fluid particles, the processor 28 will be able to provide the process control unit 40 with appropriate control information, based on the actual properties of the particles. This information can e.g. be used by an operator to control the subprocess to give particles with certain predetermined properties accordingly. Alternatively, the processor 28 provides values of the predicted particle properties to the process control unit 40 as input parameters. A feed-forward control is thus accomplished.

FIG. 3b illustrates another set-up of a general process system involving a process fluid 10. This system comprises the same units and parts as in the previous set-up, but arranged in a slightly different manner. Here, the analysing device 13 with its emitter 14 and sensor 24 is arranged on the downstream flow outlet 34, and is arranged to analyse particles within the process fluid 10, after the process fluid leaves the subprocess device 38. The processor 28 uses acoustic spectrum information to predict properties of the particles of the process fluid 10 e.g. according to a pre-calibrated model. Properties, which are of importance for how the subprocess has been performed can thereby be monitored. An operator can e.g. use this information to control the subprocess accordingly or the values of the predicted particle properties can be used as input parameters in available conventional process control means.

A process control unit 40 controls the operation parameters of the subprocess and is connected by a control connection 42 to the processor 28 of the analysing device 13. By supplying the processor 28 with information how the parameter settings of the subprocess influence the properties of the process fluid particles, the processor 28 will be able to provide the process control unit 40 with appropriate control information, based on the properties of the particles resulting from the subprocess. Alternatively, the processor 28 provides values of the predicted particle properties to the process control unit 40 as input parameters. A feed-back control is thus accomplished.

Obviously, these two different modes of system control can be combined in any configuration.

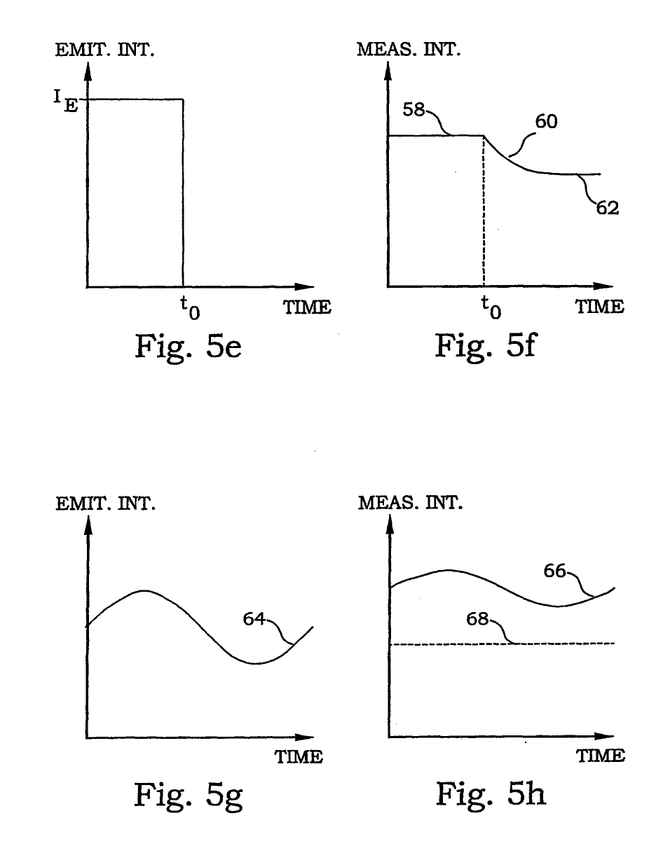

A corresponding method for system control is illustrated in the flow diagram of FIG. 4. The procedure starts in step 320. In step 322, an acoustic signal of sub-ultrasonic frequencies is emitted into a process fluid comprising suspended particles. The acoustic signals interact with the suspended particles and give rise to a resulting acoustic signal. This resulting acoustic signal is measured in step 326 and in step 328, the measurement results are evaluated, preferably in terms of properties of the particles in the fluid. The evaluated properties are preferably mechanical or chemical data, concentrations, distributions and sizes of the particles. These properties may also be connected to properties of products manufactured of the process fluid, and a corresponding evaluation for such properties is thus possible to perform. Theses properties are in step 330 used for controlling a subprocess of the system influencing the process fluid. The procedure ends in step 332.

The controllability of the acoustic source is very important. By selecting amplitude, frequency, phase and/or timing of the acoustic signals, different properties of the particles can be addressed. By controlling the frequency, the acoustic signals may e.g. be tuned to certain resonance frequencies connected to the particles, addressing specific properties. By modulating the amplitude of the signal source, noise reduction may be performed, or time dependent interactions may be emphasised or suppressed. By controlling th phase, dynamic measurements are facilitated. By controlling the timing of the acoustic signals, processes having time dependencies may be investigated. Such investigations are not possible to perform using only passive sources of acoustic signals. A few examples of simplified situations will illustrate the possibilities of controlling the signal source.

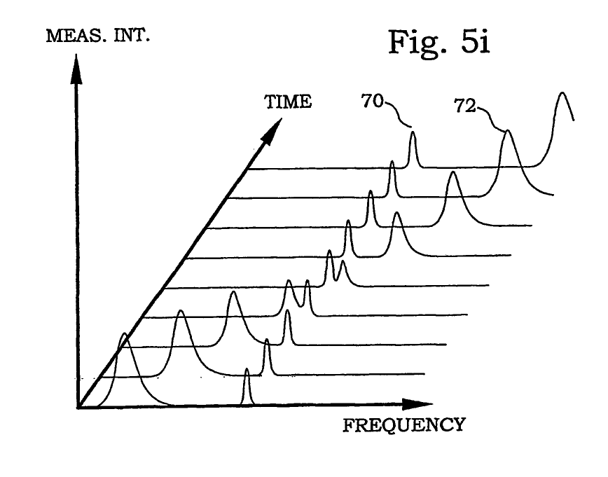

In FIG. 5a, the signal source emits an acoustic signal having one frequency f of intensity I_{E}. The frequency is tuned into a certain frequency corresponding to a characteristic frequency of the particles, e.g. an absorption frequency of particles within the process fluid. The larger density of particles, the larger absorption will result. The acoustic signal is emitted with a constant intensity I_{E} for the time the measurement lasts. By measuring the intensity 50 of the same frequency component of the resulting acoustic signal from the process fluid as a function of time, an indication of the particle density variation with time will be obtained. This is schematically illustrated in FIG. 5b. Using such a measurement, a concentration monitoring is easily performed and by introducing an interval of permitted variations, the signal may easily be used as an indicator of a too high or too low concentration.

Assuming a process fluid having solid particles of slights differing dimensions. Knowing that a certain resonance vibration is related to a certain dimension of the particle can be used to investigate the size distribution of the particles in the fluid. FIG. 5c illustrates a time dependent emitted acoustic signal. The amplitude or intensity of the signal is kept constant, while the frequency is varied linearly with time, as illustrated by the line 52 in FIG. 5c. The sensor can be operated in a co-ordinated manner, measuring the intensity of the same frequency that the acoustic source at each occasion emits. In that way, a resulting curve 54 as illustrated in FIG. 5d may be obtained. An intensity minimum 56 at the curve 54 indicates that this frequency corresponds to the median value of the dimension in question. Information about the size distribution is also obtainable.

In this manner, the frequency can be used for revealing different aspects related to the particles. The frequency may thus comprise e.g. a single constant frequency, a single frequency varying with time, a number of single constant frequencies, a number of single frequencies varying with time, or different types of limited frequency bands, such as white or pink noise.

The timing of the emitted acoustic signals may also be used, e.g. by using pulsed acoustic signals emitted during limited time intervals. FIG. 5e illustrates a simplified situation where an acoustic signal is emitted during a time interval up to the time to, when the emission is turned off. By measuring e.g. an intensity of some acoustic signal features, a curve illustrated in FIG. 5f may be obtained. This curve presents a constant level portion 58 during the time the pulse is emitted. When to is reached, the intensity starts to decrease creating a reverberation process, as shown in the portion 60, until the intensity levels out at 62. An interpretation of this behaviour could e.g. be that inherent noise within the system gives rise to an intensity of the signal feature corresponding to the level of the portion 62. This intensity would therefore correspond to background noise. Background signals in the measured acoustic signals may be reduced simply by subtracting acoustic signals measured during time intervals, in which the controllable acoustic source is inactive. The intensity difference between the portions 58 and 62 would therefore more accurately correspond to e.g. some concentration values of particles within the fluid. The detailed behaviour of the decreasing portion 60 may also give some information about e.g. mechanical interaction conditions within or around the particles. The slope could e.g. correspond to remaining vibrating particles after the turn-off of the acoustic source.

More sophisticated background reduction methods would be available by amplitude modulating the emitted acoustic signal. In FIG. 5g, the intensity of an emitted acoustic signal is varied with time according to the curve 64. A corresponding measured intensity of any acoustic spectrum feature could then vary e.g. as the curve 66 in FIG. 5h. The intensity variation is less pronounced, which implies that a background noise probably is present. By comparing the amplitude variations of the emitted and sensed signals, a background level according to the broken line 68 is found. Thus, background reduction is possible to perform also with continuously emitted signals.

From the above examples, it is obvious that the sensors should be able to measure different properties of the resulting acoustic signals. In a corresponding manner as for the emitted signals, the sensors measure e.g. amplitude, frequency, phase and/or timing of the acoustic signals resulting from the interaction with the particles in the process fluid. It is preferred if the sensors may measure at least three of the above mentioned characteristics, since a robust multivariate analysis then can be performed. The use of more variable dimensions is illustrated by a simplified example.

Assume an emitted acoustic signal according to FIG. 5c. A sensor measures an acoustic spectrum within a certain frequency interval at a number of successive times during the emission frequency scan. A possible result is shown in FIG. 5i. Two main components are present in the resulting spectrum. A first component 72 follows the emitted frequency, and a second component 70 is constant in frequency. The result indicates that the particles have a resonance frequency corresponding to a minimum intensity (max absorption) of the first component 72. However, when the emitted frequency corresponds to the second component 70, the two signals are superimposed and an intensity curve like in FIG. 5d would show a peculiar behaviour. However, following the evaluation of the spectra, the different features are easily distinguished and a correct analysis may be obtained.

The above examples are only given as oversimplified examples to increase the understanding of the possibilities of a system with controllable active acoustic sources. In real cases the situations are far more complicated and multivariate statistical analysis or neural networks are for instance used to evaluate the measured acoustic spectra.

The recorded acoustic spectra are preferably Fourier transformed to obtain intensity variations as a function of frequency. The acoustic spectra are then preferably analysed using different kinds of multivariate data analysis. The basics of such analysis may e.g. be found in “Multivariate Calibration” by H. Martens and T. Naes, John Wiley & Sons, Chicester, 1989, pp. 116-163. Commercially available tools for multivariate analysis are e.g. “Simca-P 8.0” from Umetrics or PLS-Toolbox 2.0 from Eigenvector Research, Inc. for use with MATLAB™. PLS (Partial Least Square) methods of first or second order are particularly useful. Neural network solutions, such as Neural Network Toolbox for MATLAB™, are also suitable to use for analysis purposes.

To improve the model predicting ability, a pre-treatment of spectral data is sometimes beneficial. Such a pre-treatment can include orthogonal signal correction or wavelength compression of data. Furthermore, both the real and imaginary part of the acoustic signal can be used in multivariate calculations.

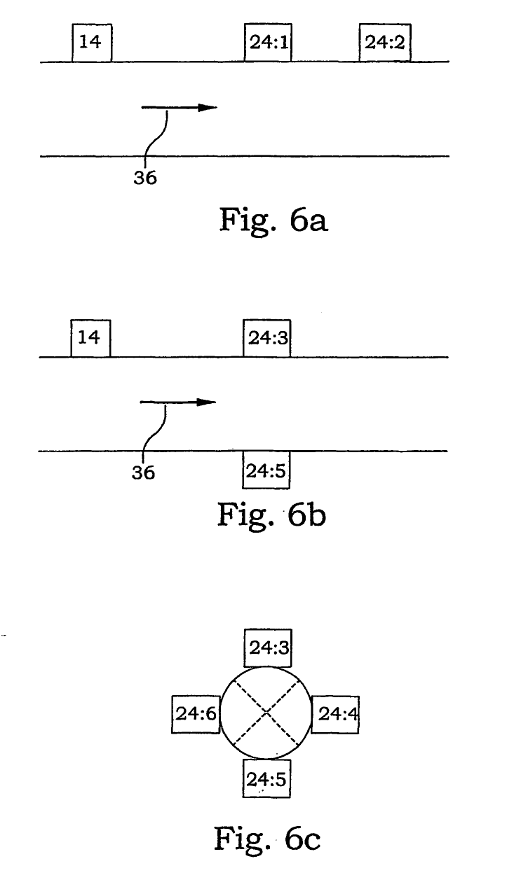

The relative geometrical positioning and/or the number of emitters and/or sensors can also be used to increase the reliability of the measured signals and thereby the properties of the particles. In FIG. 6a, a flow of process fluid is directed in the direction of the arrow 36. An emitter 14 is arranged in the upstream direction. Two sensors, 24:1, 24:2, are located downstreams at different distances from the source. By using measurements from both sensors, additional information may be obtained. One obvious possibility is to measure the propagation speed of the acoustic signals within the fluid or the flow rate, by measuring the phase shift or the time delay between the two measurements. Such information can support the interpretation of other results and may even contain its own information, e.g. the concentration of particles. The distance between the sensors is preferably in the same order of magnitude as the acoustic wavelength to allow for phase measurements. It would also be possible to detect time dependent properties of the particles. If particles are vibration excited or influenced in any other way of a acoustic pulse when passing the emitter, and the result from this excitation or influence will decay with time, the two sensors 24:1 and 24:2 will detect different time behaviour of their measurements. From the differences, information about decay times etc. may easily be obtained by computer supported analysis.

The positioning of sensors can be used also in other ways. In FIG. 6b, a system containing four sensors, of which two are shown in the sectional view along the flow direction, is illustrated. In FIG. 6c, a corresponding cross-sectional view is illustrated. The four sensors 24:3. 24:4, 24:5 and 24:6 are positioned in a plane perpendicular to the flow path 36, asymmetrically with respect to the emitter 14, but symmetrically around the pipe enclosing the process fluid flow path 36. By adding and subtracting signals from the four sensors located at one plane it is possible to extract up to four different acoustic wave types (modes). In addition a combination of the arrangements in FIGS. 6a and 6b is possible.

The acoustic signal emitter can be of different types. One obvious choice for gases is to use loudspeakers. In particular at frequencies of a few hundred Hz up to a few kHz a loudspeaker can generate high power signals without any severe problems. For hot gases or dirty environments, the loudspeaker is preferably provided with cooling facilities and protection devices, respectively. For liquid process fluids, at low and intermediate frequencies, more specially constructed sound sources has to be used. One possibility is e.g. to use an electrodynamic shaker driving a membrane or a light-weight piston.

Sensors, detecting acoustic signals, are readily available in the prior art Since the quantity of primary interest here is fluctuating pressure, the best alternative is probably to use pressure sensors or transducers. For applications in gases at normal temperatures (<70° C.) standard condenser or electric microphones are preferably used. Some well-known manufacturers are Bruel & Kjaer, Larson & Davies, GRAS. and Rion. These microphone types are sensitive and accurate, but for applications in hot or dirty environments they must be cooled and protected. Also very high levels (>140 dB) can be a problem. An alternative for hot and difficult environments is piezoelectric pressure transducers. These are much more expensive than condenser microphones but can be used up to temperatures of several hundred degrees Celsius. Drawbacks are that the pressure sensitivity is much lower than for condenser microphones and that this transducer type can pick up vibrations. An advantage is that many piezoelectric transducers can be used both in liquids and gases. However, special types for liquids also exist and are normally called hydrophones. A leading manufacturer of piezoelectric transducers is Kiestler.

If measuring the pressure, the sensor has to be in direct contact with the fluid. However, this has some obvious disadvantages since it is necessary to make a hole in a pipe or wall for mounting purposes. An alternative choice of sensors is vibration sensors, which can be mounted on a wall and measure the vibrations induced by the acoustic signals. Here, no direct contact with the fluid is required, why the mounting can be made more flexible and protected. However, a wall mounted vibration transducer will also pick up vibrations caused by other means, e.g. by machines comprised in the system. To some extent these wall vibrations will also radiate sound waves into surrounding fluid, which could be picked up by a pressure transducer, but normally, at least in gas filled systems, this effect represents a much smaller disturbance.

In cases where both amplitude and phase measurements are of interest, further dimensional limitations are put on the sensors and frequencies. In order to be able to detect the phase of an acoustic signal, the sensor has to have a size that is small compared with the wave length of the acoustic signals. This puts in practice an upper limit of the frequency that can be used. If, as an example, the phase is going to be measured by a sensor of around 1 cm in size, the wavelength of the acoustic signal should be in the order of at least 15 cm. The speed of sound in e.g. water is in the order of 1500 m/s, which means that a maximum frequency of 10 kHz can be used. Smaller sensor sizes allows higher frequencies.

As mentioned above, the particles can be of any phase; gas, liquid or solid, and of e.g. gel or sol type. However, the interaction of the acoustic signals with the particles becomes typically particularly intense if the phase of the particle matter differs from the phase of the fluid itself. The main explanation for this is the large variation in compressibility that normally exists between different phases. Thus are solid particles in liquid or gas, liquid particles in gas and gas particles in liquids good measurements targets.

Regarding vibration transducers, the standard choice for all frequencies used in the present invention is so called accelerometers, which typically are piezoelectric sensors that gives an output proportional to acceleration. Regarding manufacturers the ones already listed for condenser microphones also apply in this case.

The analysis device and method according to the present invention can be applied in many various fields. A couple of examples will be described briefly below.

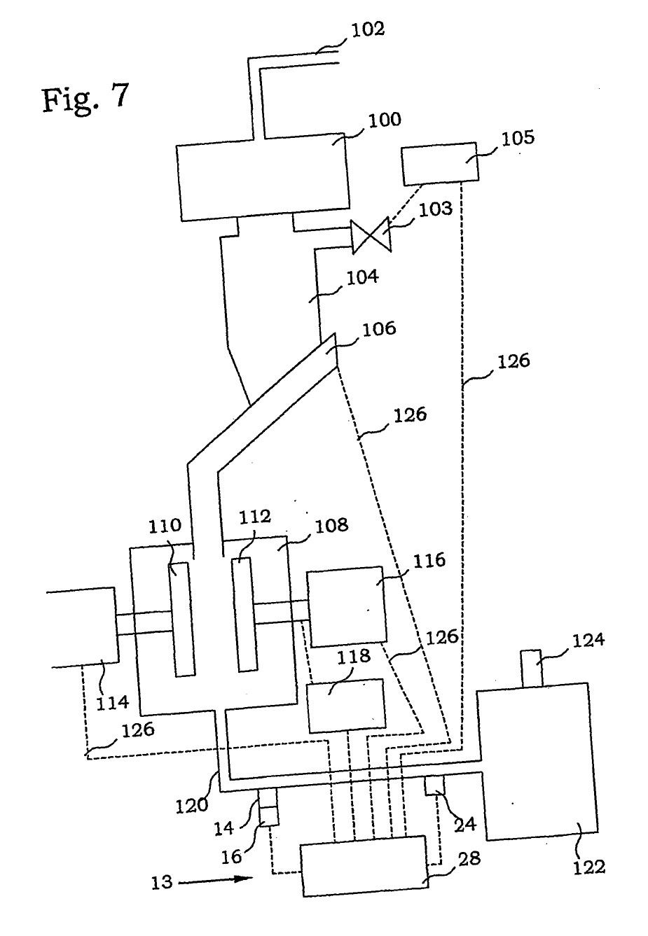

In the pulp and paper industry, the acoustic sensor could be installed in all positions where a flow or transportation of pulp is performed. A position of particular interest is in the vicinity of the refiner. The refiner is the most important subprocess step in mechanical pulping and there exist very clear economical benefits for implementation of a more advanced control of the refiner based on new information. FIG. 7 illustrates a typical example of a refiner part of a mechanical pulping process system. A pressurising unit 100 is supplied with pre-treated wood chips through a supply line 102. The pressurised chips is supplied to a container unit 104, where the chips is mixed with water 105. A screw device 106 brings the mixture with a certain determined rate into a refiner unit 108. The refiner 108 schematically illustrated in FIG. 7 comprises double discs 110, 112, between which the chip mixture is fed. Each disc 110, 112 has a respective motor 114, 116, which applies the necessary rotary motion to the refiner discs 110, 112. A refiner force control device 118 regulates the force with which the refiner discs 110, 112 are pulled together. The chips are mined between the discs, separating the wood fibres.

After refining, the ground pulp fibres suspended in the water mixture exits the refiner at high pressure via an exit pipe 120. The high pressure is reduced, which causes some of the (by the refining process) heated water to evaporate into steam. The steam 124 is separated from the fibre mixture in a cyclone 122 before the fibres are introduced into the following pulping process steps.

An emitter 14 with a control unit 16 is arranged at the exit pipe 120. A sensor 24 is also arranged at the exit pipe a distance from the emitter 14. The emitter 14 and sensor 24 are connected to an evaluation unit 28 comprising a processor. The emitter 14 is controlled to emit acoustic signals into the pulp mixture within the edit pipe 120. The sensor 24 records the resulting acoustic signals and the processor 28 evaluates the results.

Paper strength issues are a vast area with many different laboratory measurement methods and evaluation possibilities. Nevertheless, it is probably the most common and important quality parameter demanded by the customers. Basically, the final paper strength is influenced by three parameters; the single fibre intrinsic strength, the area of fibre-to-fibre bond per length unit of the fibre and the strength of each fibre bond. Longer fibres will provide opportunities for more fibre-to-fibre bonds and therefore the fibre network will be stronger and consequently also the paper. If the fibres are excited, the vibrate with different frequencies depending on their length. The point of self oscillation will be at a lower frequency for long fibres compared to short ones.

Furthermore, the above property of the refined pulp mixture depends on certain input parameters of the refining process. The first parameter is the type and quality of the wood chips. Such information can be entered into the control system e.g. by an operator. Other parameters which determines the effect of the refining is the water content, the rate in which the chips are entered into the refiner, the disc velocity and the force between the refiner discs 110, 112. The relations between these parameters and the properties of the pulp are normally rather well known, or may be obtained empirically. Based on such relations, the analysing device 13 may find appropriate changes in the settings of the disc speed, disc force, water content or chip feeding speed by signal connections 126 in order to improve the properties of the resulting fibres. The analysing device thus constitutes a feed-back system, operating on the final process fluid from the refiner subprocess.

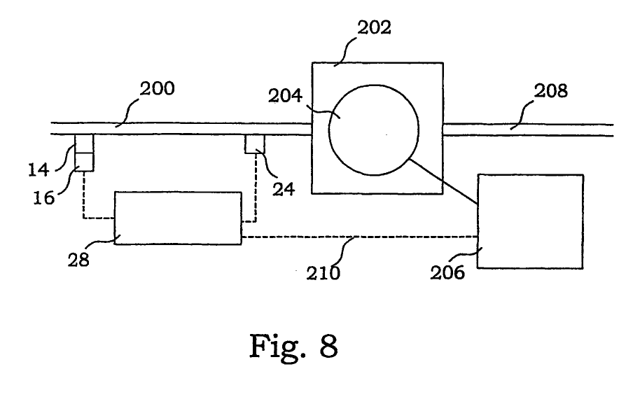

Another example of a process system for which the present invention is suited is pharmaceutical manufacturing. In certain process lines, liquid particles of active substances are produced in a dilute form and are further processed in a refiner, in order to increase the active substance content. FIG. 8 schematically illustrates a refining subprocess system. An introduction pipe 200 feeds dilute substance fluid into the refiner 202, which comprises separating elements 204. The speed and position of the separating elements 204 determines the ratio between the original active substance content and the final active substance content. A control unit 206 controls the operation of the separator elements. The high concentration fluid leaves the refiner in an exit pipe 208.

The actual concentration of active substance in the original fluid may vary considerably due to production processes that are difficult to control in a totally consistent manner. The operation of the refiner 202 thus has to be adjusted to the differing raw material, i.e. to the actual active substance concentration of the incoming fluid.

An emitter 14 with a control unit 16 is arranged at the introduction pipe 200. A sensor 24 is also arranged at the introduction pipe a distance from the emitter 14. The emitter 14 and sensor 24 are connected to an evaluation unit 28 comprising a processor. The emitter 14 is controlled to emit acoustic signals into the fluid within the exit pipe 120. The sensor 24 records the resulting acoustic signals and the processor 28 evaluates the results.

The active substance exists as small droplets emulgated in the fluid. The substance droplets have different acoustic properties as compared with the remaining part of the fluid. The changing properties makes the droplets in the emulsion to scattering objects for acoustic signals. The scattering properties are determined basically by the droplet size and droplet density. An acoustic signal emitted into the fluid will interact with the substance droplets and result in a resulting acoustic signal, which can be detected. The actual features of the detected signal depends on the droplet size and droplet density, i.e. on the active substance concentration. The processor 28 may therefore evaluate the active substance concentration of the introduced raw fluid. By knowing the relations between the operating conditions of the refiner and the substance concentration ratio, the operation of the refiner can be controlled continuously by the acoustic monitoring, by control connections 210 to the control unit 206, in order to produce a well controlled active substance concentration in the outgoing process fluid.

The method according to the present invention may be implemented as software, hardware, or a combination thereof. A computer program product implementing the method or a part thereof comprises a software or a computer program run on a general purpose or specially adapted computer, processor or microprocessor. The software includes computer program code elements or software code portions that make the computer perform the method using at least one of the steps previously described in FIG. 6. The program may be stored in whole or part, on, or in, one or more suitable computer readable media or data storage means such as a magnetic disk, CD-ROM or DVD disk, hard disk, magneto-optical memory storage means, in RAM or volatile memory, in ROM or flash memory, as firmware, or on a data server.

It will be understood by those skilled in the art that various modifications and changes may be made to the present invention without departure from the scope thereof, which is defined by the appended claims.

### REFERENCES

D. J. Adams: “Ultrasonic propagation in paper fibre suspensions”, 3rd International IFAC Conference on Instrumentation and Automation in the Paper, Rubber and Plastics Industries, p. 187-194, Noordnederlands Boekbedrijf, Antwerp, Belgium.

M. Karras, E. Harkonen, J. Tornberg and O. Hirsimaki: “Pulp suspension flow measurement using ultrasonics and correlation”, 1982 Ultrasonics Symposium Proceedings, p. 915-918, vol. 2, Ed: B. R. McAvoy, IEEE, New York, N.Y., USA.

French patent FR 2 772 476.

International patent application WO 99/15890.

H. Martens and T. Naes: “Multivariate Calibration”, John Wiley & Sons, Chicester, 1989, pp. 116-163.

1. A method for analysis of a process fluid (10), being a suspension of particles (12), said particles (12) being volumes of gas, liquid or solid phase, said method comprising the steps of:
emitting acoustic signal into said process fluid (10);
measuring acoustic signals from said process fluid (10); and
predicting, from said measured acoustic signals mechanical/chemical properties of said process fluid (10), characterised in that
said emitting step comprises emitting of controllable acoustic signal (18), being controllable by frequency, amplitude, phase and/or timing, into said process fluid (10) for interaction of said controllable acoustic signal (18) with said particles (12), being responsive to acoustic signals;
said measuring step comprises measuring of a spectrum of acoustic signals (22) from said process fluid (10), resulting from said interaction of said controllable acoustic signal (18) and said particles (12), said spectrum comprising frequencies below 20 kHz; and
said predicting step comprises predicting, both from said measured spectrum of acoustic signals (22) and in view of the controlling of said controllable acoustic signal, mechanical/chemical properties of said particles (12) in said process fluid (10).

2. A method of system control for handling of a process fluid (10), being a suspension of particles (12), said particles (12) being volumes of gas, liquid or solid phase, said method comprising the steps of:
emitting acoustic signal into said process fluid (10); and
measuring acoustic signals from said process fluid (10), characterised in that
said emitting step comprises emitting of controllable acoustic signal (18), being controllable by frequency, amplitude, phase and/or timing into said process fluid (10) for interaction of said controllable acoustic signal (18) with said particles (12), being responsive to acoustic signals;
said measuring step comprises measuring of a spectrum of acoustic signals (22) from said process fluid (10), resulting from said interaction of said controllable acoustic signal (18) and said particles (12), said spectrum comprising frequencies below 20 kHz;
and by the further steps of:
determining at least one process control parameter based both on said measured acoustic signals (22) and in view of the controlling of said controllable acoustic signal; and
controlling a subprocess influencing mechanical/chemical properties of said particles (12) in said fluid (10) according to said determined processcontrol parameter(s).

3. A method according to claim 2, characterised in that said determining step in turn comprises the step of predicting, from said measured acoustic signals (22), said properties of said particles (12) in said process fluid (10).

4. A method according to claim 2 or 3, characterised in that measuring of acoustic signals (22) from said process fluid (10) is performed downstream relative to said subprocess, providing a feed-back of the result of the subprocess.

5. A method according to claim 2 or 3, characterised in that measuring of acoustic signals (22) from said process fluid (10) is performed upstream relative to said subprocess, providing a feed-forward from the process fluid entering the subprocess.

6. A method according to any of the claims 1 to 5, characterised in that at least one of said properties of said particles being selected from the list of:
mechanical property,
chemical property,
concentration,
shape, and
size.

7. A method according to any of the claims 1 to 6, characterised in that said process fluid (10) is selected from the list of:
a gas containing solid particles,
a gas containing liquid droplets,
a suspension of solid particles in a liquid,
an emulsion of liquid droplets in a liquid,
a liquid containing gas volumes, and
a combination of at least two of the other alternatives in this list.

8. A method according to claim 7, characterised in that said particles (12) being of a phase, different from the phase of said fluid (10).

9. A method according to any of the claims 1 to 8, characterised in that said emitted acoustic signal (18) is composed by acoustic waves having a large wave length compared to a typical size of said particles (12) and a typical distance between said particles (12).

10. A method according to any of the claims 1 to 9, characterised in that said step of measuring spectral component(s) comprises measuring, for at least one frequency, at least one of the properties in the list of:
amplitude,
phase, and
time-delay.

11. A method according to claim 10, characterised in that said step of measuring spectral component(s) comprises measuring, for at least one frequency, at least two of the properties in the list of:
amplitude,
phase, and
time-delay.

12. A method according to claim 9, characterised by the further step of tuning frequency/frequencies of said controllable acoustic signal (18) to characteristic frequencies of said particles (12).

13. A method according to any of the claims 1 to 12, characterised in that said controllable acoustic signal (18) is pulsed and emitted during limited time intervals.

14. A method according to any of the claims 1 to 13, characterised by the further steps of:
amplitude modulating of said controllable acoustic signal (18); and
reducing background signals in said measured acoustic signals (22), based on said amplitude modulation.

15. A method according to any of the claims 1 and 3 to 14, characterised in that said step of predicting further comprises the step of predicting, from said measured acoustic signals (22), properties of products manufactured by said process fluid (10).

16. A method according to any of the claims 1 and 3 to 15, characterised in that said step of predicting comprises multivariate statistical analysis of said measured acoustic signals (22).

17. A method according to any of the claims 1 and 3 to 16, characterised in that said step of measuring acoustic signals (22) comprises measuring of acoustic signals (22) at at least two positions (24:1-24:6) in connection with said process fluid (10), whereby said predicting step is based on measured acoustic signals (22) from said at least two positions (24:1-24:6).

18. A method according to claim 17, characterised in that at least two of said measuring positions (24:1, 24:2) are for the frequencies used separated a distance smaller than the acoustic wavelength in a direction substantially along a flow path (36) for said process fluid (10).

19. A method according to claim 17 or 18, characterised in that at least two of said measuring positions (24:3-24:6) are located in a plane substantially perpendicular to a flow path (36) for said process fluid (10).

20. A method according to claim 17, 18 or 19, characterised in that said predicting step further comprises the step of decomposing said measured acoustic signals (22) into different propagating acoustic modes (wave types).

21. An analysing apparatus for analysis of a process fluid (10), being a suspension of particles (12), said particles (12) being volumes of gas, liquid or solid phase, said apparatus comprising:
acoustic signal source (14);
acoustic signal sensor (24) for measuring of acoustic signals (22) from said process fluid (10); and
data processing means (28) including a processor and connected to said acoustic signal sensor (24) for predicting of mechanical/chemical properties,
characterised by further comprising:
control means (16) for controlling said acoustic signal source (14) by frequency, amplitude, phase and/or timing; and in that
said acoustic signal source (14) being arranged to emit a controllable acoustic signal (18) into said process fluid (10) for interaction with said particles (12);
that said acoustic signal sensor (24) is arranged for measuring a spectrum of acoustic signals (22) resulting from said interaction of said controllable acoustic signal (18) and said particles (12), said spectrum comprising frequencies below 20 kHz; and
that said processor is arranged for predicting, both from said measured spectrum of acoustic signals (22) and in view of the controlling of said controllable acoustic signal, mechanical/chemical properties of said particles (12).

22. A process apparatus for handling a process fluid (10), being a suspension of particles (12), said particles (12) being volumes of gas, liquid or solid phase, said apparatus comprising:
means (38) for carrying out a subprocess influencing mechanical/chemical properties of said particles (12) in said fluid (10);
acoustic signal source (14); and
acoustic signal sensor (24) for measuring acoustic signals (22) from said process fluid (10), characterised:
by further comprising control means (16) for controlling said acoustic signal source (14) by frequency, amplitude, phase and/or timing;
in that said acoustic signal source (14) being arranged to emit a controllable acoustic signal (18) into said process fluid (10) for interaction with said particles (12);
in that said acoustic signal sensor (24) is arranged for measuring a spectrum of acoustic signals (22) resulting from said interaction of said controllable acoustic signal (18) and said particles (12), said spectrum comprising frequencies below 20 kHz;
by further comprising data processing means (28) including a processor and connected to said acoustic signal sensor (24) for determination of at least one process control parameter based both on said measured spectrum of acoustic signals (22) and in view of the controlling of said controllable acoustic signal; and
means (40) for controlling said means (38) for carrying out a subprocess according to said determined process control parameter(s).

23. An apparatus according to claim 22, characterised in that said data processing means (28) is further arranged for predicting, from said measured acoustic signals (22), said properties of said particles (12) in said process fluid (10).

24. An apparatus according to claim 22 or 23, characterised in that at least one acoustic signal sensor (24) is positioned downstream relative to said means (38) for carrying out said subprocess, providing a feed-back of the result of the subprocess.

25. An apparatus according to claim 22, 23 or 24, characterised in that at least one acoustic signal sensor (24) is positioned upstream relative to said means (38) for carrying out said subprocess, providing a feed-forward from the process fluid (10) entering the subprocess.

26. An apparatus according to any of the claims 21 to 25, characterised in that at least one of said properties of said particles being selected from the list of:
mechanical property,
chemical property,
concentration,
shape, and
size.

27. An apparatus according to any of the claims 21 to 26, characterised in that said process fluid (10) is selected from the list of:
a gas containing solid particles,
a gas containing liquid droplets,
a suspension of solid particles in a liquid,
an emulsion of liquid droplets in a liquid,
a liquid containing gas volumes, and
a combination of at least two of the other alternatives in this list.

28. An apparatus according to claim 27, characterised in that said particles (12) being of a phase, different from the phase of said fluid (10).

29. An apparatus according to any of the claims 21 to 28, characterised in that said acoustic signal sensor (24) has a small size compared to the wave length of waves emitted by said acoustic signal source (14).

30. An apparatus according to any of the claims 21 to 29, characterised in that said acoustic signal sensor (24) is sensitive for frequencies below 20 kHz.

31. An apparatus according to any of the claims 21 to 30, characterised in that said acoustic signal sensor (24) is arranged for measuring, for at least one frequency, at least one of the properties in the list of:
amplitude,
phase, and
time-delay.

32. An apparatus according to claim 31, characterised in that said acoustic signal sensor (24) is arranged for measuring, for at least one frequency, at least two of the properties in the list of:
amplitude,
phase, and
time-delay.

33. An apparatus according to claim 30, characterised in that said control means (16) comprises means for tuning the frequency/frequencies of said controllable acoustic signal (18) to characteristic frequencies of said particles (12).

34. An apparatus according to any of the claims 21 to 33, characterised in that said control means (16) comprises means for causing said acoustic signal source (14) to emit during limited time intervals.

35. An apparatus according to any of the claims 21 to 34, characterised in that said control means (16) further comprises amplitude modulation means for said controllable acoustic signal (18), and in that the apparatus further comprises means for reducing background signals in said measured acoustic signals (22), connected to said control means (16), for receiving information about said amplitude modulation.

36. An apparatus according to any of the claims 21 and 23 to 35, characterised in that said data processing means (28) is further arranged for predicting, from said measured acoustic signals (22), properties of products manufactured by said process fluid (10).

37. An apparatus according to any of the claims 21 and 23 to 36, characterised in that data processing means (28) comprises means for multivariate statistical analysis of said measured acoustic signals (22).

38. An apparatus according to any of the claims 21 and 23 to 37, characterised by at least one additional acoustic signal sensor (24:1-24:6) at (an)other position(s) in connection with said process fluid (10), connected to said data processing means (28).

39. An apparatus according to claim 38, characterised in that at least two of said acoustic signal sensors (24:1, 24:2) are for the frequencies used separated a distance smaller than the acoustic wavelength in a direction substantially along a flow path (36) for said process fluid (10).

40. An apparatus according to claim 38 or 39, characterised in that at least two of said acoustic signal sensors (24:3-24:6) are separated substantially perpendicularly to a flow path (36) for said process fluid (10).

41. An apparatus according to claim 38, 39 or 40, characterised in that said data processing means (28) further comprises means for decomposing said measured acoustic signals (22) into different propagating acoustic modes (wave types).

42. An apparatus according to any of the claims 21 to 41, characterised in that at least one acoustic signal sensor (24) is an acoustic pressure or a motion sensor.

43. An apparatus according to any of the claims 21 to 42, characterised in that at least one acoustic signal sensor (24) is attached on the outside of an enclosure of said process fluid (10).

44. An apparatus according to any of the claims 21 to 43, characterised in that said acoustic signal source (24) is selected in the list of:
an electrodynamic loudspeaker, and
an electrodynamic shaker connected to a piston or a membrane.

45. A computer program product comprising computer code means and/or software code portions for making a processor perform the steps of any of the claims 1 to 21.

46. A computer program product according to claim 45 supplied via a network, such as Internet.

47. A computer readable medium containing a computer program product according to claim 45 or 46.
